(19) United States
(12) Patent Application Publication
(10) Pub. No.: US 2010/0146104 A1
(43) Pub. Date: Jun. 10, 2010

(54) SYSTEM AND METHOD FOR DETECTING A REMOTE APPARATUS

(75) Inventors: Ping Yu CHEN, Sigang Township (TW); Nien Chin Wu, Tainan City (TW); Jin Neng Wu, Sihhu Township (TW); Yung Shun Huang, Tainan City (TW)

Correspondence Address: EGBERT LAW OFFICES, 412 MAIN STREET, 7TH FLOOR, HOUSTON, TX, 77002, US

(73) Assignee: INDUSTRIAL TECHNOLOGY RESEARCH Institute, Hsinchu (TW)

(21) Appl. No.: 12/426,153

(22) Filed: Apr. 17, 2009

(30) Foreign Application Priority Data
Dec. 10, 2008 (TW) 097147948

(51) Int. Cl. G06F 15/173; G06F 15/16

(52) U.S. Cl. 709/224; 709/230

(57) ABSTRACT

A system for detecting a remote apparatus includes a host and a remote interface device connected to the host via a network. The remote interface device includes at least one serial port configured for connecting to a serial port apparatus. The remote interface device detects the connection status of the serial port using a filter rule provided by the host. When the connection status is changed, the remote interface device sends an event notification to the host. The host adds or removes virtual port objects, which are used by application software and are configured to control the remote apparatus, according to the received event notification. Using the mechanism described above, the host can have remote plug and play feature on a remote serial port apparatus.

### CROSS-REFERENCE TO RELATED APPLICATIONS

Not applicable.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

1. Field of the Invention

The present invention relates to a system and method for detecting a remote apparatus.

2. Description of Related Art Including Information Disclosed Under 37 CFR 1.97 and 37 CFR 1.98.

Generally, a computer has a limited number of serial ports. When large numbers of serial ports are required, ports other than serial ports, for example Ethernet ports, can be converted to serial ports using serial-Ethernet conversion techniques to meet the requirement. In addition to increasing the available number of serial ports, converting Ethernet ports to serials ports has another advantage in that those serial ports can be accessed via a network, or, in other words, apparatuses connected to those serial ports can be controlled via a network. Therefore, using serial-Ethernet conversion techniques, a computer system can not only have more serial ports, but can also control the serial ports in remote locations from the computer system via a network.

However, conventional converters developed by the serial-Ethernet conversion techniques have no plug and play feature. When the converters are applied, manual set-up procedures have to be followed, and the serial ports cannot be used until the setup is finished. The usability and manageability of such converters still need to be improved. Moreover, because there is no standard communications protocol that can be applied to inform a host whether apparatuses are connected to or disconnected from the remote serial ports controlled by the host, the host must use a polling program that can verify the connection status of the remote serial ports and provide the information, such as internet protocol addresses and types of serial ports, of the apparatuses connected to the remote serial ports by polling operation. However, the host has to regularly perform polling operations to make sure the serial port connection status, and such regular polling operations will increase the loading of the host and slow down the network.

In summary, conventional serial-Ethernet converters increase the number of available serial ports for a computer system. A host can use the conventional serial-Ethernet converters to control remote apparatuses connected thereto. However, the host has to perform polling operations to confirm the connection statuses between the serial ports and the apparatuses, and such polling operations will consume a lot of resources of the host and result in an increase in the network load. Therefore, an improvement for the deficiencies of the converters is required.

### BRIEF SUMMARY OF THE INVENTION

The exemplary embodiments of the invention propose a system for detecting a remote apparatus, which comprises a host and a remote interface device, wherein the remote interface device comprises a serial port configured for a remote apparatus. The host comprises a host communication module and a virtual port administration module configured to provide a filter rule employed to administrate a remote apparatus. The remote interface device comprises a device communication module, a remote serial port implementation module, and a detecting module. The device communication module communicates with the host communication module via a network and the host communication module and the device communication module automatically search and connect with each other. The remote serial port implementation module is configured to provide an event notification via the device communication module. The detecting module is configured to detect the connection status of the remote apparatus using the filter rule, and cause the remote serial port implementation module to send an event notification to the host when the connection status of the remote apparatus is changed.

The exemplary embodiments of the invention propose a method for detecting a remote apparatus, which comprises the steps of: selecting a serial port of a remote interface device; detecting a connection status between the serial port of the remote interface device and a remote apparatus using at least one filter rule that is provided by a host and corresponds to the remote apparatus; waiting for a response message from the serial port; determining the connection status based on the result of comparing the response message and the filter rule; and sending an event notification to the host if the connection status is changed.

### BRIEF DESCRIPTION OF THE SEVERAL VIEWS OF THE DRAWINGS

The invention will be described according to the appended drawings.

FIG. 1 is a diagrammatic illustration showing a system for detecting a remote apparatus according to one embodiment of the present invention.

FIG. 2 is a diagrammatic illustration showing a hardware structure of a host and a remote interface device according to one embodiment of the present invention.

FIG. 3 is a diagrammatic illustration showing a software structure of the system for detecting a remote apparatus according to one embodiment of the present invention.

FIG. 4 is a diagrammatic illustration showing the establishment of virtual port objects according to one embodiment of the present invention.

FIG. 5 is a flow chart showing a process describing the detection and identification operations of a newly added remote apparatus according to one embodiment of the present invention.

FIG. 6 is a flowchart showing a removal process in the detection and identification operations of a remote apparatus according to one embodiment of the present invention.

FIG. 7 is a diagrammatic illustration showing a filter rule according to one embodiment of the present invention.

FIG. 8 is a diagrammatic illustration showing communication modular structure in a host according to one embodiment of the present invention.

FIG. 9 is a diagrammatic illustration showing communication modular structure in a remote interface device according to one embodiment of the present invention.

### DETAILED DESCRIPTION OF THE INVENTION

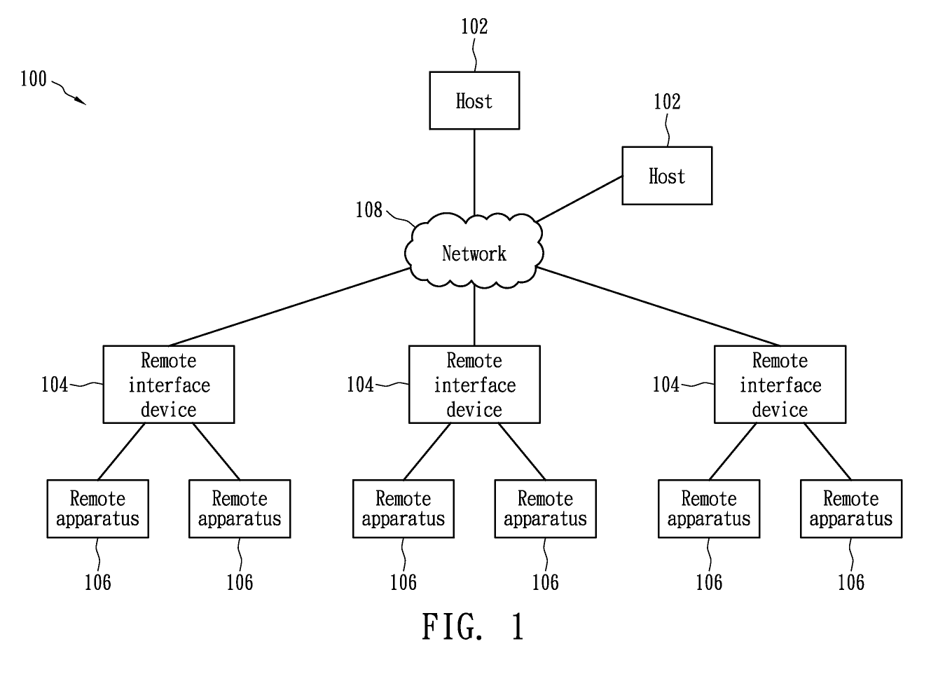

FIG. 1 shows a system 100 for detecting a remote apparatus according to one embodiment of the present invention. A system 100 for detecting a remote apparatus comprises at least one host 102 and at least one remote interface device 104. The remote interface device 104 comprises at least one serial port, and at least one remote apparatus 106 is connected to the corresponding serial port of the remote interface device 104. The host 102, via a network 108, controls the remote apparatus 106 through the remote interface device 104 using a communication protocol. The communication protocol may comprise Discovery protocol, Description protocol, Control protocol, and Generic Event Notification Architecture.

Generally, the connection between the host 102 and the remote interface device 104 can be configured manually or automatically. In one exemplary auto-configuration implementation, when the remote interface device 104 connects to the network 108, the remote interface device 104 may obtain an Internet protocol (IP) address for configuration from a DHCP (Dynamic Host Configuration Protocol) server. In another exemplary implementation, the remote interface device 104 may auto-configure an IP address using Auto-IP. After the IP address of the remote interface device 104 is determined, the remote interface device 104 broadcasts its presence to the network 108. The host 102 can know the presence of the remote interface device 104 from broadcast messages and connect to the remote interface device 104. In addition, another method to establish the connectivity between the host 102 and the remote interface device 104 is that the host 102 searches for a remote interface device 104 via the network 108, and after the host 102 receives a response message from the remote interface device 104, the host 102 connects to the remote interface device 104 according to the response message.

The host 102 can discover the remote interface device 104 using Discovery protocol, and then establish communication with the remote apparatus 106 connected to the remote interface device 104. The host 102 can also retrieve the Description Document, providing connected apparatus information and services, of the remote interface device 104 based on Description protocol; the host 102 can send control commands to control the remote apparatus 106 connected to the remote interface device 104 based on Control protocol; and the host 102 can receive event notification based on Generic Event Notification Architecture when services provided by the remote interface device 104 are changed.

The remote apparatuses 106 connect to the remote interface devices 104 via the respective serial ports. The serial port can include any type of serial communication physical interface, for example, RS232, RS422, RS485, and infrared communications ports.

The network 108, connecting the host 102 and the remote interface device 104, can be any type of network or in any network topology. The network 108 may comprise wired local area network and a wireless local area network.

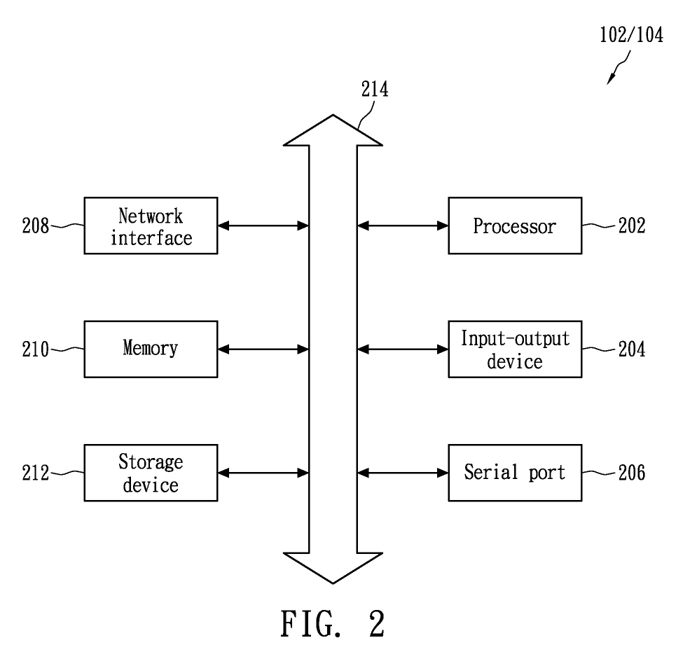

FIG. 2 shows a hardware structure of a host 102 and a remote interface device 104 according to one embodiment of the present invention. Referring to FIG. 1 and FIG. 2, both the host 102 and the remote interface device 104 comprise a processor 202, a memory 210, an input-output device 204, serial ports 206, a network interface 208, and a storage device 212, and a system bus 214. The processor 202 comprises a microprocessor and a micro-controller. The memory 210 comprises a volatile memory and a non-volatile memory. The input-output device 204, used for inputting and outputting information to control the host 102 and the remote interface device 104, may comprise a mouse, a keyboard, a scanner, a printer, and a display, an audio/video device, and interfaces for other digital input-output devices. The serial port 206 comprises, for example, RS232, RS422, RS485, infrared communications ports, and other devices transmitting data in a serial manner. The network interface 208, providing the host 102 and the remote interface device 104 to connect to each other via the network 108, may comprise a telephone modem, a cable modem, DSL or ADSL modem, and ISDN modem. The storage device 212, configured to store all operating software and data generated during operation, may comprise readable and/or writable storage means, for example a hard disc, soft disc, an optical disc drive and a flash memory data storage device. The system bus 214, configured for the exchanges of information between the processor 202, the memory 210, the input-output 204, the serial ports 206, the network interface 208, and the storage device 212, may comprise PCI (Personal Component Interconnect) bus, ISA (Industry Standard Architecture) bus and VME (Versa Module Europa) bus. The host 102 may comprise a mobile computing device and a fixed computing device such as a notebook, a desktop computer, a server or a workstation. The remote interface device 104 is mainly configured to make an apparatus with a serial port connector operable via the network 108. The remote interface device 104 may be an embedded device, a portable computing device or a fixed computing device such as a personal digital assistant, a notebook or a desktop computer.

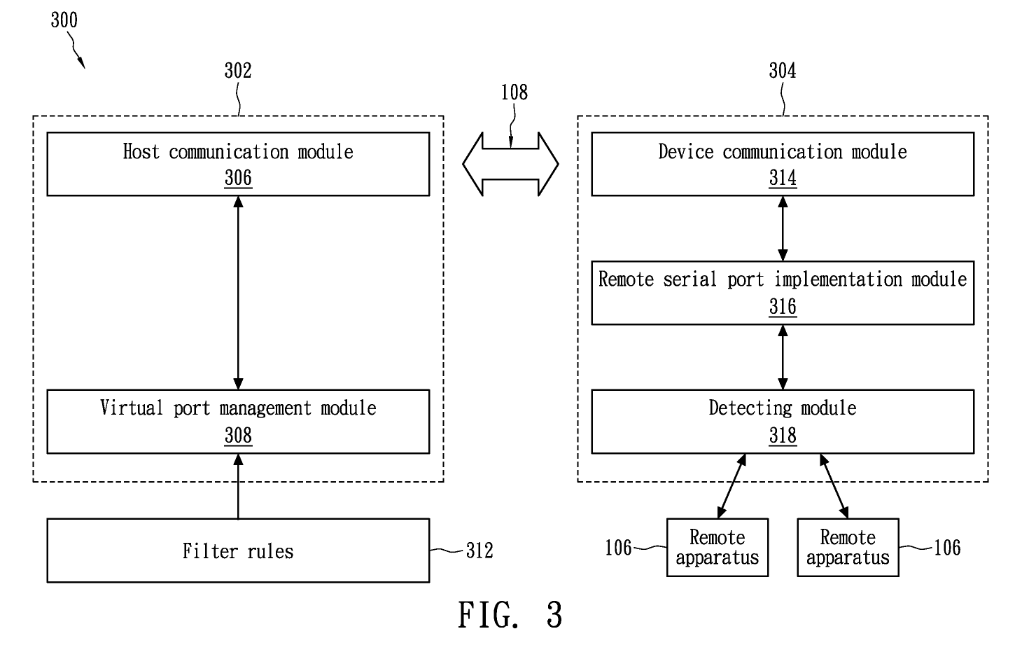

FIG. 3 shows a software structure 300 of the system 100 for detecting a remote apparatus according to one embodiment of the present invention. Referring to FIG. 1 and FIG. 3, the system software structure 300 of the present invention comprises a virtual interface control driving module 302 residing in the host 102 and a remote detecting agent 304 residing in the remote interface device 104. The virtual interface control driving module 302 comprises a host communication module 306 and a virtual port management module 308. The virtual port management module 308 is configured to provide filter rules used for administrating remote apparatuses 106 and configured for administration (including establishment and removal) of the virtual port objects, which are used by application software and correspond to the remote apparatuses 106, according to the results generated from the detection and verification operations of the remote interface device 104 to the remote apparatuses 106 connected therewith. The virtual port object is configured to make application software to use commands that directly control the remote apparatuses 106. The application software residing in the host 102 can control the remote apparatuses 106 directly just as the remote apparatuses 106 are locally connected to the host 102. The host communication module 306 is configured to automatically search the remote interface devices 104 in the network 108 and communicate with those that are connected to the network 108.

The remote detecting agent 304 comprises a device communication module 314, a remote serial port implementation module 316 and a detecting module 318. The device communication module 314 and the host communication module 306 communicate with each other using a communication protocol, wherein the host communication module 306 and the device communication module 314 automatically search and connect with each other via the network 108 based on the communication protocol. The remote serial port implementation module 316 is configured to implement discovery operation, description operation, control operation, and event notification operation via the device communication module 314. Using the discovery protocol, the remote interface device 104 can find the host 102 in the network 108; using the control protocol, the remote interface device 104 can send control commands to other interface devices; using the description protocol, the remote interface device 104 can provide description documents defining services, data types, command execution status notices and actions; using the generic event notification architecture, the host 102 can subscribe to receive event notifications of serial port connection status from the remote interface device 104. The detecting module 318 uses filter rules 312 to detect the connection statuses of remote apparatuses 106, and if any connection status is changed, an event notification of connection change is sent to the host 102 based on event notification mechanism. When the remote interface device 104 has multiple serial ports correspondingly connected to different remote apparatuses, the detecting module 318 sequentially detects and identifies the connection status of each apparatus 106 by a polling operation, and filter rules 312 corresponding to the apparatuses 106 are applied to detect and identify the connection status of each serial port. When the detecting module 318 finds the connection status of one apparatus 106 is changed, an event notification of connection change is sent to the host 102 based on generic event notification architecture.

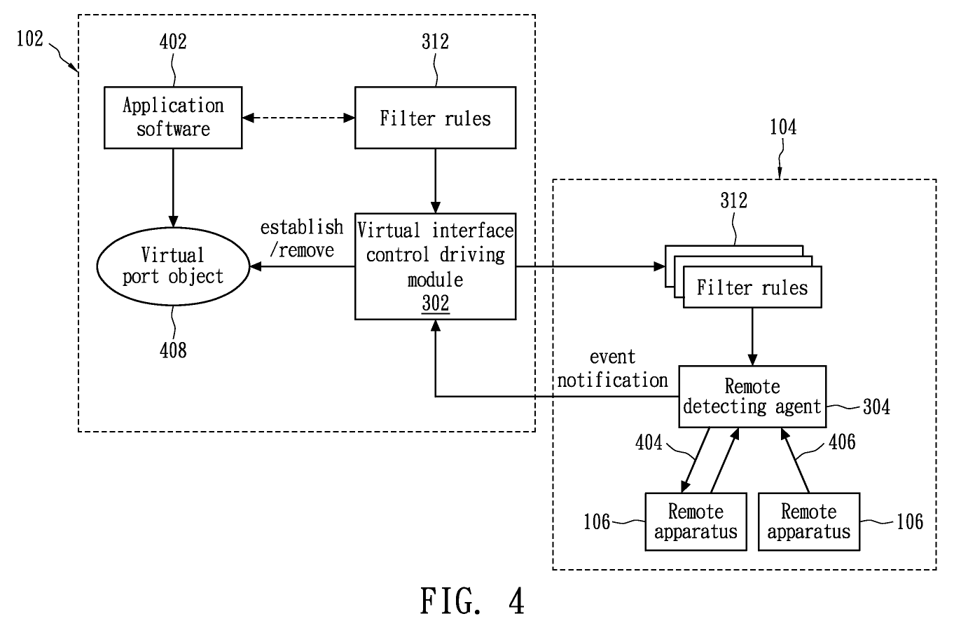

FIG. 4 is a diagram showing the establishment of virtual port objects according to one embodiment of the present invention. Referring to FIG. 3 and FIG. 4, the virtual interface control driving module 302 residing in the host 102 initially sends filter rules 312, which are used to detect and verify the connection statuses of respective remote apparatuses 106 controlled by application software 402, to remote interface devices 104. The remote detecting agent 304 of each remote interface device 104, using the filter rules 312, sequentially detect, identify, and verify the connection status of each apparatus 106 connected therewith by polling operations. The embodiment of the present invention moves the detection and identification operations that the application software 402 conventionally requires to confirm connection statuses of the remote apparatuses 106 to the remote interface device 104 such that the remote interface device 104 takes responsibility for detecting and identifying the remote apparatuses 106 so as to reduce the operating loading of the host 102 and network load, and allows the host 102 to have plug-and-play operability.

The detection or identification operation, performed by the remote detecting agent 304 for the remote apparatuses 106, can be an active operation 404 or a passive operation 406. The active operation 404 is performed by sending an identification message first, and then verifying according to a received response message. In the mode of the passive operation 406, the remote detecting agent 304 waits to receive a reporting message, and compares the reporting message to the respective filter rule 312. The remote detecting agent 304 can also determine the connection status based on the expiry of a usage time.

When the connection status of a remote apparatus 106 is changed, the remote detecting agent 304 sends an event notification to the virtual interface control driving module 302 responsible for the remote apparatus 106. When a new remote apparatus 106 is connected to the remote interface device 104, the remote detecting agent 304 sequentially detects each serial port of the remote interface device 104 using a filter rule 312 corresponding to the new remote apparatus 106. If a response message is matched to the filter rule 312, the virtual interface control driving module 302 establishes a respective virtual port object 408 for application software 402 according to an event notification. When a remote apparatus 106 is removed, the response message does not conform to the respective filter rule 312, and an event notification is sent to cause the virtual interface control driving module 302 to remove the respective virtual port object 408.

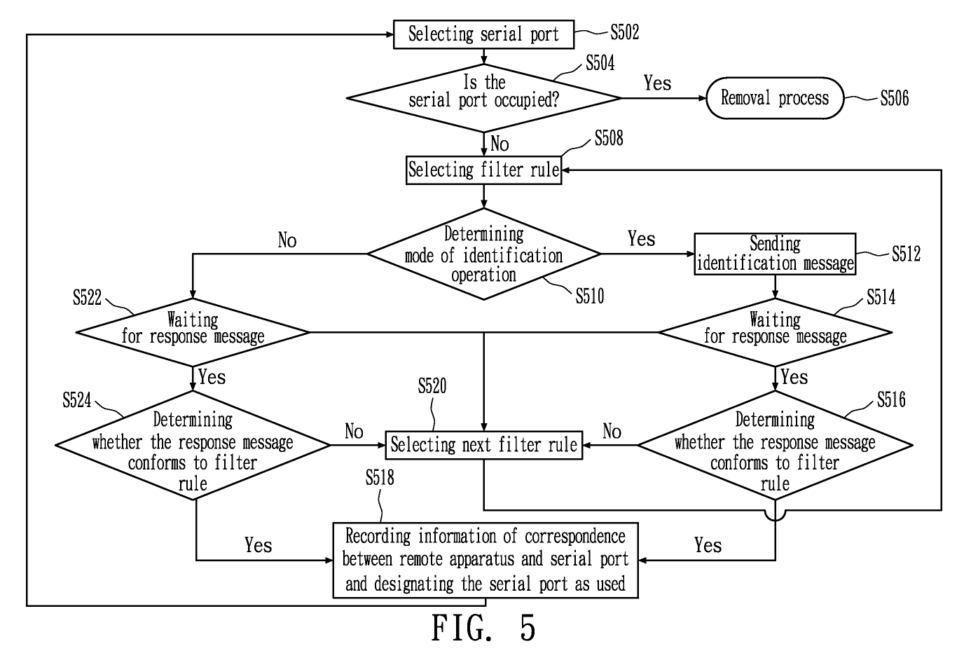

FIG. 5 is a flowchart showing a process describing the detection and identification operations of a newly added remote apparatus according to one embodiment of the present invention. At Step S502, the detecting module residing in a remote interface device selects a serial port. At Step S504, the detecting module determines whether the serial port is occupied. If the serial port is occupied, the process proceeds to a removal process (Step S506). Otherwise, the process proceeds to the next step. At Step S508, the detecting module selects a filter rule and retrieves parameters from the filter rule. At Step S510, the detecting module selects the mode of identification operation. At Step S512, if the active operation is selected, the detecting module sends an identification message corresponding to the filter rule. At Step S514, after the identification message is sent out, the detecting module waits for the respective response message. At Step S516, if a response message is received, the detecting module determines whether the response message conforms to the filter rule. At Step S518, if the response message conforms to the filter rule, the serial port is connected with the predetermined remote apparatus that the host is configured to control. Thereafter, the detecting module records the information of the correspondence between the remote apparatus and the serial port, and designates the serial port as used. At Step S520, if the response message does not conform to the filter rule, the detecting module selects the next filter rule. At Step S522, if the passive operation is selected, the detecting module waits for a response message. At Step S524, if a response message is received, the detecting module determines whether the response message conforms to the filter rule. If the response message conforms to the filter rule, the process proceeds to Step S518; if not, the process proceeds to Step S520.

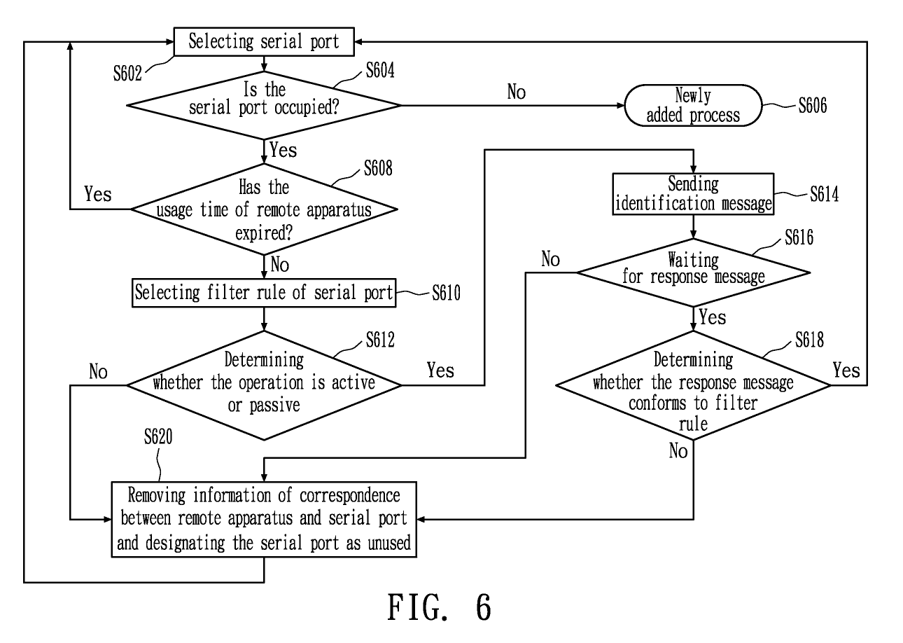

FIG. 6 is a flowchart showing a removal process for the detection and identification operations of a remote apparatus according to one embodiment of the present invention. At Step S602, the detecting module residing in a remote interface device selects a serial port. At Step S604, the detecting module determines whether the serial port is occupied. If the serial port is not occupied, the process proceeds to a newly added process (Step S606). Otherwise, the process proceeds to Step S608. At Step S608, the detecting module determines whether the usage time of the remote apparatus has expired. If the usage time has not expired, the removal process proceeds to Step S602. At Step S610, the detecting module selects a filter rule and retrieves parameters from the filter rule. At Step S614, if the detecting module selects the active operation, the detecting module sends an identification message corresponding to the filter rule. At Step S616, after the identification message is sent out, the detecting module waits for the respective response message. At Step S618, if a response message is received, the detecting module determines whether the response message conforms to the filter rule. At Step S620, if the response message conforms to the filter rule, the removal process proceeds to Step S602. If the response message does not conform to the filter rule, the detecting module deletes the information of the correspondence between the remote apparatus and the serial port, and designates the serial port as unused. At Step S616, if the detecting module has not received any response message over a predetermined time, the removal process proceeds to Step S620. At Step S612, if the detecting module selects the passive operation, the removal process proceeds to Step S620, and the remote apparatuses, for which the usage time has expired with no response messages sent, and the virtual port objects corresponding thereto, will be removed.

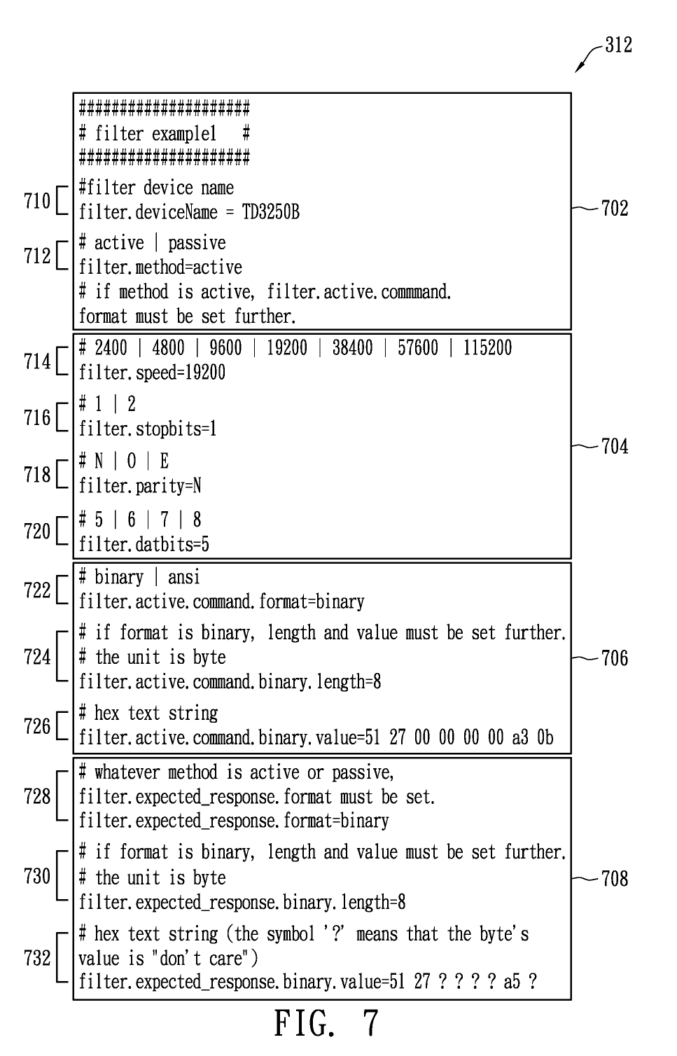

FIG. 7 is a filter rule 312 according to one embodiment of the present invention. Referring to FIG. 4 and FIG. 7, the filter rule 312 is used by a remote detecting agent 304 to verify the connection statuses of remote apparatuses by polling serial ports. The content of the filter rule 312 depends on the type of serial port. The present embodiment discloses the filter rule 312 of a RS232 port as an example, and the present invention is not limited to the disclosed filter rule 312 and the mechanism of the filter rule 312. The content of the filter rule 312 comprises basic parameter setup section 702, serial port parameter setup section 704, active operation mode setup section 706 and expected response parameter setup section 708. The content in the basic parameter setup section 702 comprises a device name input field 710 and a filter method selection field 712. The content in the serial port parameter setup section 704 comprises a speed field 714, a stop bit field 716, a parity field 718, and a data bit field 720. The content in active operation mode setup section 706 comprises an active command format field 722, a binary command length field 724, and an identification text string field 726. The identification text string is enclosed within an identification message used for identification of remote apparatuses. The content of the expected response parameter setup section 708 comprises an expected response format field 728, an expected response length field 730, and an expected response value field 732. When a remote detecting agent 304 receives the response message that contains the same text string as that of the expected response value field 732, the verified remote apparatus 106 sending out the response message conforms to the filter rule 312.

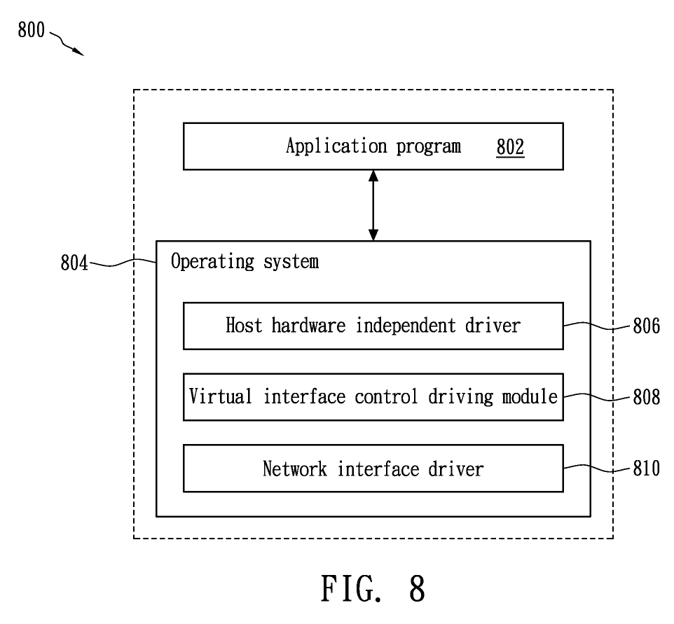

FIG. 8 is a schematic diagram showing the communication modular structure in a host 102 according to one embodiment of the present invention. Referring to FIG. 1 and FIG. 8, the host software structure 800 comprises application programs 802 configured for an interface used to operate the corresponding remote apparatus 106, an operating system 804, a host hardware independent driver 806 configured to drive the corresponding remote apparatus 106, a virtual interface control driving module 808 and a network interface driver 810. An application program 802 sends out a control command, the virtual interface control driving module 808 and the host hardware independent driver 806 transfer the control command and then transmit to a remote apparatus 106 via the network interface driver 810 so that a user can use the application program 802 and remotely control the remote apparatus 106.

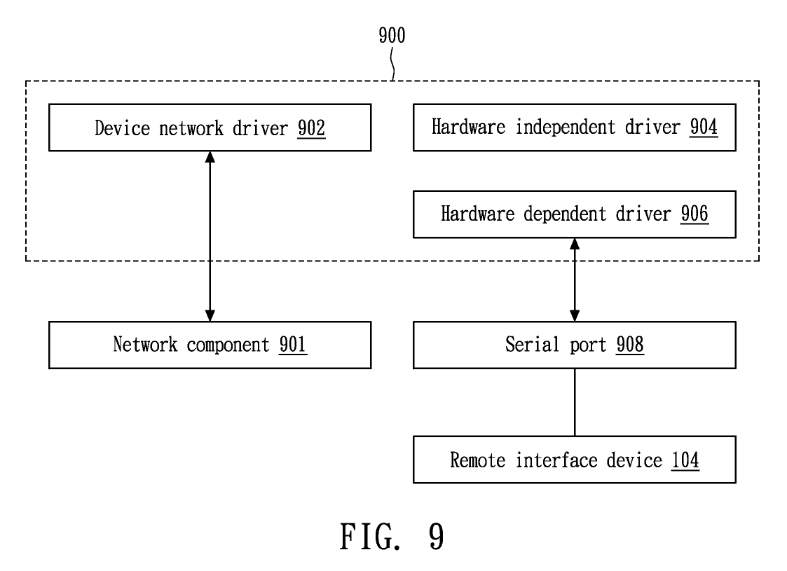

FIG. 9 is a schematic diagram showing the communication modular structure in a remote interface device according to one embodiment of the present invention. Referring to FIG. 1 and FIG. 9, the software structure 900 of a remote interface device comprises a device network driver 902 configured to control a network component 901, a hardware independent driver 904 configured to support a serial port 908, and a hardware dependent driver 906, wherein the serial port 908 is connected with a remote apparatus 106. The control command received by the device network driver 902 is transferred by the hardware independent driver 904 and the hardware dependent driver 906, and then is transmitted to the remote apparatus 106. The response message from the remote apparatus 106 is transmitted in the reverse direction.

The above-described embodiments of the present invention are intended to be illustrative only. Numerous alternative embodiments may be devised by persons skilled in the art without departing from the scope of the following claims.

1. A system for detecting a remote apparatus, comprising:
a host coupled to a network, the host comprising:
a host communication module; and
a virtual port administration module configured to provide a filter rule employed to administrate a remote apparatus; and
a remote interface device comprising:
a serial port connectable to the remote apparatus, the remote interface device comprising:
a device communication module configured to communicate with the host communication module, wherein the host communication module and the device communication module automatically search and connect with each other via the network;
a remote serial port implementation module configured to provide an event notification via the device communication module; and
a detecting module configured to detect the connection status of the remote apparatus using the filter rule, and cause the remote serial port implementation module to send an event notification to the host when the connection status of the remote apparatus is changed.

2. The system for detecting a remote apparatus of claim 1, wherein the remote serial port implementation module is further configured to implement a subscription operation.

3. The system for detecting a remote apparatus of claim 1, wherein the virtual port administration module is further configured to remove a virtual port object corresponding to the remote apparatus when the detecting module receives a response message that does not conform to the filter rule.

4. The system for detecting a remote apparatus of claim 1, wherein the virtual port administration module is further configured to establish a virtual port object when the detecting module receives a response message that conforms to the filter rule, from a newly connected remote apparatus.

5. The system for detecting a remote apparatus of claim 1, wherein the virtual port administration module is further configured to remove a virtual port object corresponding to the serial port when the detecting module has not received a response message after expiration of a usage time.

6. The system for detecting a remote apparatus of claim 1, wherein the remote serial port implementation module is further configured to implement a communication protocol, and the communication protocol comprises a discovery protocol, a description protocol, a control protocol and a generic event notification architecture.

7. The system for detecting a remote apparatus of claim 6, wherein the host subscribes to the event notification according to the generic event notification architecture.

8. The system for detecting a remote apparatus of claim 1, wherein the network comprises a wired local area network and a wireless local area network.

9. The system for detecting a remote apparatus of claim 1, wherein the serial port is RS232, RS422, RS485 or infrared communications port.

10. The system for detecting a remote apparatus of claim 1, wherein the remote interface device obtains an Internet protocol address using an auto configuration protocol.

11. A method for detecting a remote apparatus, the method comprising steps of:
selecting a serial port of a remote interface device;
detecting a connection status between the serial port of the remote interface device and a remote apparatus using at least one filter rule that is provided by a host and corresponding to the remote apparatus;
waiting for a response message from the serial port;
determining the connection status based on the result of comparing the response message and the filter rule; and
sending an event notification to the host if the connection status is changed.

12. The method for detecting a remote apparatus of claim 11, further comprising:
sending an identification message, wherein the response message is sent according to the identification message if matched.

13. The method for detecting a remote apparatus of claim 11, further comprising:
verifying expiration of a usage time of the serial port.

14. The method for detecting a remote apparatus of claim 13, further comprising:
removing a virtual port object of the host, corresponding to the remote apparatus after the expiry of a usage time of the serial port.

15. The method for detecting a remote apparatus of claim 11, further comprising:
removing the host's virtual port object corresponding to the remote apparatus when the response message does not conform to the filter rule.

16. The method for detecting a remote apparatus of claim 15, further comprising:
designating the serial port as unused.

17. The method for detecting a remote apparatus of claim 11, further comprising:
establishing the host's virtual port object corresponding to the remote apparatus when the remote apparatus is connected to the serial port and the response message conforms to the filter rule.

18. The method for detecting a remote apparatus of claim 17, further comprising:
designating the serial port as used.

19. The method for detecting a remote apparatus of claim 11, further comprising:
automatically searching and connecting to the host by the remote interface device.
